(19) United States
(12) Patent Application Publication
(10) Pub. No.: US 2004/0182427 A1
(43) Pub. Date: Sep. 23, 2004

(54) Method and apparatus for channeling debris in a swimming pool

(76) Inventor: John M. Goettl, Phoenix, AZ (US)

Correspondence Address: C. Robert von Hellens, CAHILL, VON HELLENS & GLAZER P.L.C., 2141 East Highland Avenue, Suite 155, Phoenix, AZ, 85016, US

(21) Appl. No.: 10/392,606

(22) Filed: Mar. 19, 2003

(51) Int. Cl. B08B 3/00

(52) U.S. Cl. 134/36; 134/94.1; 134/179; 134/180

(57) ABSTRACT

A plurality of incrementally rotating nozzles are mounted in the bottom and side walls of a swimming pool provide bursts of water to channel in a cascade manner debris toward outlets disposed in the bottom of the pool.

### BACKGROUND OF THE INVENTION

Because the desire to maintain a swimming pool clean and crystal clear has been with us for decades, various devices and methods have been developed in an attempt to obtain these results. These devices and methodologies attempt to direct debris in a swimming pool toward an outlet in communication with a filtration system that returns the pool water after the debris has been removed by filtration. Early on, such apparatus included a plurality of “whips” extending from various locations in the side walls which ejected water. The act of ejection caused the whips to move about in an essentially random fashion. The resulting randomly directed outflow of water tended to perform a washing action against the bottom surface and side walls to cause the debris to become suspended in the pool water and to move other debris along the respective surface. The suspended debris ultimately flowed into an outlet and was thereby removed from the pool. One of the main problems with such whips is that sections of the side walls and bottom surface tended to be undisturbed by a flow of water from the whips and debris would collect in these sections. This was a particular problem with debris too dense to remain suspended in the pool water.

In an attempt to overcome the deficiencies of the whips, nozzles of various types were located in the side walls and bottom surface of the pool for ejecting a flow of water against the respective side walls and bottom surface. These multiple water flows had the effect of stirring the debris to attempt to entrain or suspend it in the swimming pool water for ultimate transport to an outlet. Debris that was not readily suspended would tend to collect on surfaces that had no or a low flow rate of water passing there across. Because the purpose of the nozzles was primarily that of randomly stirring the debris, the outflows of adjacent nozzles tended to be toward one another and had minor effective result of channeling the debris to an outlet.

Because of the ongoing interest of keeping swimming pools clean, various inventions have been conceived and disclosed in a number of United States patents, as set forth below. U.S. Pat. No. 3,045,829 describes a plurality of nozzles mounted in the bottom of a swimming pool to provide an outflow to an outlet or drain. Further nozzles are located in the side walls to provide lateral and downward water flow. All of these nozzles provide water flow simultaneously which requires a relatively massive motor for driving a pump having a sufficient water flow rate to be effective. U.S. Pat. No. 3,506,489 describes a plurality of bottom and side wall mounted nozzles in a swimming pool which are sequentially operated. The nozzles may be of the rotating type. The net effect is, at best, that of maintaining fine debris suspended but there is no teaching of channeling the non suspended debris to an outlet. U.S. Pat. No. 3,521,304 describes a rotating nozzle for directing a flow of water along the adjacent pool surface and also upwardly away from the surface in an attempt to maintain debris suspended. Because of the rotating nature of the nozzles, the flow of water and any entrained debris is cause to flow not only toward an outlet but also away from the outlet and the effectiveness of expunging the debris is severely compromised. U.S. Pat. No. 3,449,772 discloses a plurality of sequentially operating nozzles for the purpose of sweeping debris. Because of the rotating feature of the nozzles, any debris or sediment is directed not only toward the outlet but also away from the outlet. U.S. Pat. No. 3,247,969 is directed to apparatus for introducing filtered water to a pool through bottom surface mounted nozzles in an effort to move sediment. U.S. Pat. No. 5,135,579 describes an invention made by the present inventor. This patent illustrates nozzles located on opposed side walls and on the bottom for directing a flow of water downwardly along the side walls and across the bottom to an outlet.

### BRIEF SUMMARY OF THE INVENTION

Water is discharged through a plurality of rotatable nozzles actuated in a predetermined sequence to channel in a cascade manner debris along the surfaces of the bottom and side walls of a swimming pool to one or more outlets. Depending upon placement in either the bottom or side walls of a swimming pool, the nozzles sequentially step through 90 degrees (90°), 180 degrees (180°), 360 degrees (360°) or an other angle; that is, the extent of rotation is a function of the location of each nozzle and the nature of the downstream surface extending toward the existing outlet(s). By sequentially operating the nozzles relative to one another, debris is directed from the surface area of influence of one nozzle to a downstream surface area of influence of a successive nozzle until the debris is ultimately channeled to an outlet.

It is therefore a primary object of the present invention to locate selectively actuatable partially and fully rotatable nozzles in the bottom and side walls of a swimming pool to channel debris toward and into an outlet.

Another object of the present invention is to provide partially and fully rotatable nozzles disposed in the bottom and side walls of a swimming pool for channeling debris in a cascade manner to an outlet.

Still another object of the present invention is to provide partially and fully rotatable nozzles disposed in the bottom and side walls of a swimming pool ejecting water in bursts lasting in the range of about thirty (30) seconds to about one (1) minute to channel debris in a cascading manner to an outlet.

Yet another object of the present invention is to provide nozzles in the bottom surface and side walls of a swimming pool which rotate through a predetermined angle as a function of their location to augment and maintain movement of debris toward an outlet in a swimming pool.

A further object of the present invention is to provide a method for cleaning a swimming pool by channeling debris toward an outlet in response to sequential water flows from discretely located nozzles, some of which nozzles may be partially rotatable while others may be fully rotatable.

A still further object of the present invention is to provide a method for incorporating selectively actuated nozzles rotatable a predetermined number of degrees as a function of the location of the nozzle and the adjacent surface of a swimming pool to channel debris toward an outlet.

A yet further object of the present invention is to provide a plurality of nozzles for channeling debris along the bottom surface and side walls of a swimming pool to an outlet.

These and other objects of the present invention will become apparent to those skilled in the art as the description there proceeds.

### BRIEF DESCRIPTION OF THE DRAWINGS

The present invention will be described with greater specificity and clarity with reference to the following drawings, in which:

FIGS. 1 and 2 illustrate perspective and cross sectional views, respectively, of a conventional pool having conventional 360 degree (360°) rotatable nozzles mounted in the bottom surface and side walls;

FIGS. 3 and 4 illustrate a perspective view and a cross sectional view, respectively, of a swimming pool having an arrangement of rotatable nozzles operating in the manner of the present invention;

FIGS. 5 and 6 illustrate a perspective view and a cross sectional view, respectively, of a swimming pool having a variant arrangement of rotatable nozzles functioning to channel debris to an outlet;

FIGS. 7 and 8 illustrate a perspective view and a cross sectional view, respectively, of a plurality of selectively actuated nozzles operating to channel debris into either of two outlets;

FIG. 9 illustrates a perspective view of a swimming pool similar to the pool shown in FIGS. 7 and 8 but having a single outlet located in a corner with partially rotating nozzles in the side walls to develop a debris collection zone about the outlet;

FIG. 10 illustrates selectively actuatable nozzles and an outlet for creating a zone to collect debris about a centrally located outlet; and

FIGS. 11 and 12 illustrate a perspective view and a cross sectional view, respectively, of a vinyl lined pool having a hopper section and selectively actuated nozzles for directing debris to a pair of outlets.

### DESCRIPTION OF THE INVENTION

Debris in a pool is primarily of three types. Very fine clay and fine vegetative matter can be maintained in suspension for eventual removal by a filteration system of a swimming pool. Heavy debris, such as sand, leaves, gravel and the like is not suspendable and must be moved to a location where it can be withdrawn from the swimming pool through an outlet adapted for this purpose. Other debris too large to pass through the outlet must be withdrawn by other means. The present invention is primarily directed to removal of the second type of debris although it will have a beneficial effect on the other types of debris.

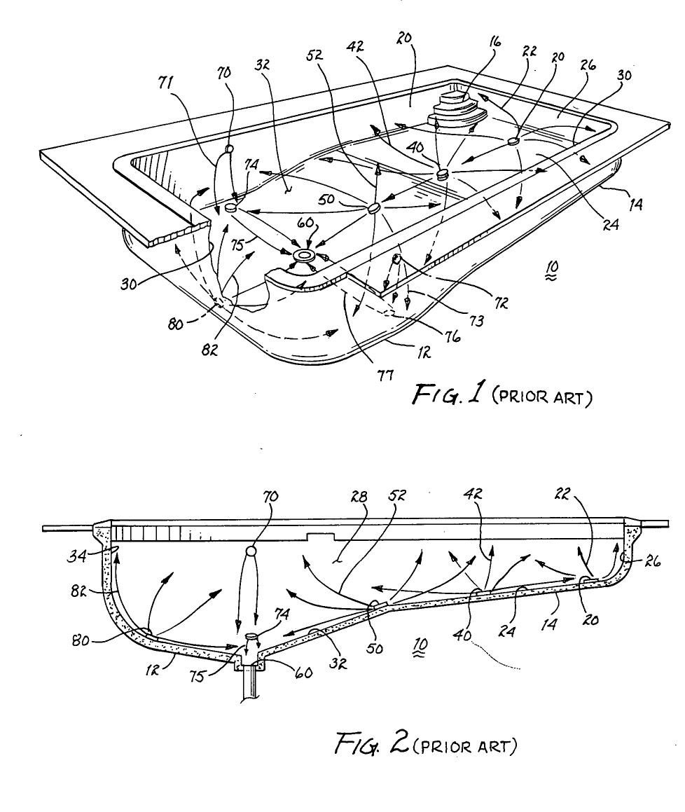

Referring jointly to FIGS. 1 and 2, there is illustrated a conventional swimming pool 10 having a deep end 12 and a shallow end 14. As illustrated, one of the corners at the shallow end includes steps 16. Generally, one or more nozzles 20 disposed close to the extremity of the shallow end rotates 360 degrees (360°) incrementally in a step manner to discharge bursts of water. As illustrated by arrows 22 emanating from nozzle 20, each burst of water performs a washing or scrubbing action along the path of water flow. The plurality of paths jointly direct water away from the nozzle along bottom surface 24, end surface 26 and each of side walls 28, 30. Moreover, one or more bursts of water will tend to wash/scrub the surfaces of steps 16 with greater or lesser degree of success. The effect of nozzle 20 is primarily that of attempting to suspend debris in the pool water and it may have a secondary effect of directing debris lying on the bottom surface and side walls away from the nozzle.

Generally, a distance toward deep end 12 from nozzle 20 is located one or more further nozzles 40. This nozzle(s) rotates 360 degrees (360°) in a step manner like nozzle 20 and directs sequential bursts of water in a successive omni directional manner, as represented by arrows 42. As it becomes quickly evident by inspection, the bursts of water directed toward shallow end 14 will interfere with and counter, to a greater or lesser extent, the bursts of water emanating from nozzle 20 toward deep end 12. Thereby, any suspended debris or debris on the surfaces initially directed toward the deep end may be halted and directed toward the shallow end or toward either of the side walls of the pool. A certain number of the bursts of water emanating from nozzle 40 and conveying debris will be directed toward deep end 12. By inspection, it becomes evident that the opposing bursts of water flow between nozzles 20 and 40 are generally counter productive in channeling debris in an organized manner in a predetermined common direction.

Generally, a further nozzle 50 or sets of nozzles are disposed in the steep inclined section 32 of the pool bottom surface. Nozzle(s) 50 is similar to nozzles 20, 40 and incrementally provides bursts of water in a sequential rotation pattern extending through 360 degrees (360°). Again, certain of the bursts of water, as depicted by arrows 52, are directed toward the shallow end and oppose or otherwise counteract the beneficial bursts of water flow from nozzle 40 toward the deep end. Thereby, debris initially directed toward the deep end may be halted or urged laterally toward the side walls of the pool or toward the shallow end. Certain of the bursts of water from nozzle(s) 50 will urge bursts of water toward outlet 60 and convey debris to the outlet. Some debris on the bottom surface of the pool will be encouraged to roll or slide downwardly along the inclined section 32 toward outlet 60. Nevertheless, the bursts of water from nozzles 50, 40 toward one another will be counterproductive in channeling debris toward the outlet.

To assist in channeling debris into outlet 60, a pair of nozzles 70, 72 are disposed on opposed side walls of pool 10 and may direct a steady flow of water downwardly, as represented by arrows 71, 73, respectively. A further pair of nozzles 74, 76 are located proximate the junction of the pool side walls and the bottom surface. These nozzles provide steady flow of water toward outlet 60 as represented by arrows 75, 77, respectively. Thereby, the downward flow of debris proximate nozzles 70, 72 is continued by the steady flow of water from nozzles 74, 76 until the debris is ultimately conveyed to outlet 60. It may be appreciated that any debris conveyed by the bursts of water from nozzle 50 into functional engagement with the flows of water from nozzles 74, 76 will be encouraged to migrate toward outlet 60. This apparatus and method are described with greater specificity in U.S. Pat. No. 5,135,579, which patent is owned by the present assignee and incorporated herein by reference.

Generally, a nozzle 80 (or a plurality of nozzles 80) is disposed proximate the junction of the bottom surface of swimming pool 10 and end wall 34 at deep end 12. This nozzle provides sequential bursts of water incrementing through 360 degrees (360°) to scrub/wash a circular pattern about nozzle 80. As represented by arrows 82, only some of the bursts of flow of water will convey debris toward outlet 60. Furthermore, certain of these bursts of water will countermand the effects of water flows from nozzles 70, 72, 74, 76 and possibly even from nozzle(s) 50.

In conclusion, prior art nozzles in pools tend to stir up debris to place it in suspension to the extent it is suspendable with the apparent hope that ultimately the suspended debris will migrate toward an outlet and ultimately be removed by the filtration system attendant the swimming pool. As is clearly represented in FIGS. 1 and 2, there is no concerted effort or even capability of channeling non suspended debris to an outlet directly and in a cascade manner.

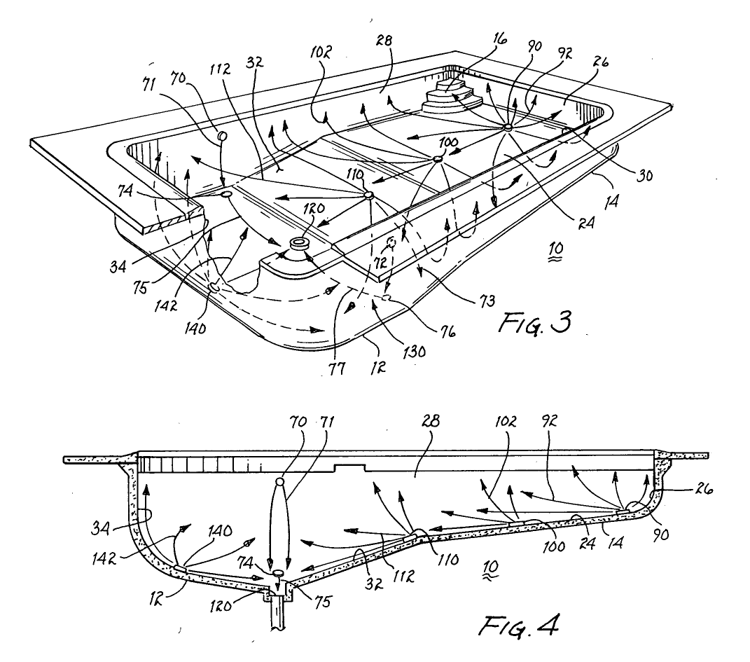

Referring jointly to FIGS. 3 and 4 there is illustrated a pool similar in type to that shown in FIGS. 1 and 2; however, the system of incrementally rotating nozzles disposed therein provides an effect and a result completely different from that described above. One or more nozzles 90 are disposed in bottom surface 24 close to end wall 26. Nozzle(s) 90 incrementally rotate 360 degrees (360°) to provide bursts of water at successive angular orientations, as reflected by arrows 92. The bursts of water generally directed toward end wall 26 will tend to wash/scrub the intervening bottom surface and the end wall. Furthermore, these bursts of water will cause the water to flow laterally along the end wall to the corresponding side walls 28, 30 and transport debris therewith. Steps 16 will be similarly periodically scrubbed/washed to remove debris thereon or place the debris in suspension proximate thereto. The sequential bursts of water (arrows 92) directed laterally toward end walls 28, 30 will tend to mix with water flows along the respective side wall caused by bursts of water deflected laterally upon striking end wall 26. Thus, these flows of water generally toward deep end 12 will be augmented by other bursts of water flow to continue to transport debris therewith. Bursts of water directly or generally toward the deep end will tend to channel debris there along.

Nozzle 100 is an incrementally rotating nozzle rotating through approximately 180 degrees (180°) or somewhat less. All bursts of water from nozzle 100, as depicted by arrows 102, will be either laterally or toward the deep end. Thus, any debris conveyed toward the deep end as a result of bursts (arrows 92) of water from nozzle(s) 90 will be enhanced and augmented by the flows of water from nozzle(s) 100. Thereby, the debris is channeled toward the deep end, first by nozzle(s) 90 and then by nozzle(s) 100.

Further nozzles 110 disposed in inclined section 32 are nozzles incrementally rotating through 180 degrees (180°) or somewhat less. As depicted by arrows 112, the incremental bursts of water from nozzle(s) 110 will direct the water and any debris laterally toward side walls 28, 30 but primarily downwardly along inclined section 32 and toward outlet 120. The debris caused to be conveyed toward the deep end by bursts of water from nozzle(s) 100 will become entrained with the bursts of water from nozzle(s) 110 and the conveyance of the debris will be augmented. This results in a channeling of the debris toward a collection zone attendant outlet 120 at the deep end.

Nozzles 70, 72 in side walls 28, 30 and nozzles 74, 76 therebeneath and essentially on opposed sides of outlet 120 are part of a cleaning system described in detail in U.S. Pat. No. 5,135,579 and comprises an invention by the present inventor. This cleaning system, in essence, causes any debris flowing along the side walls or the bottom into proximity therewith to be channeled toward outlet 120. Thereby, any suspended debris flowing along side walls 28, 30, as well as any debris flowing along bottom surface 24 and inclined surface 32 will become subjected to the influence of the cleaning system and be channeled toward and into outlet 120.

One or more further nozzles 140 may be disposed proximate the junction of bottom surface 24 and end wall 34 at deep end 12. Nozzle(s) 140 steps through 360 degrees (360°) to provide successive angularly displaced bursts of water, represented by arrow 142, to wash/scrub the adjacent pool surfaces. Any resulting debris placed in suspension or caused to slide along the surfaces will tend to be transported laterally, in which event the debris will come under the influence of the cleaning system and be channeled to outlet 120 or downwardly either directly toward outlet 120 or angularly displaced therefrom but ultimately coming under the influence of the flows of water from nozzles 74, 76.

To be effective to establish a water flow along a surface, a burst of water from each incremental position of a nozzle should continue for a period in the range of about thirty (30) seconds to about one (1) minute. Thus, the nozzles described with reference to FIGS. 3 and 4 and the nozzles to be described with respect to the remaining Figures would have bursts of a duration in this range. The nozzles described with respect to FIGS. 3 and 4 and to be described with reference to the remaining Figures may be described as incrementally rotating through an angle of 90 degrees (90°), 180 degrees (180°) or 360 degrees (360°). However, depending upon the location of the nozzle, the degree of incremental rotation may be through any angle between 0 degrees (0°) and 360 degrees (360°).

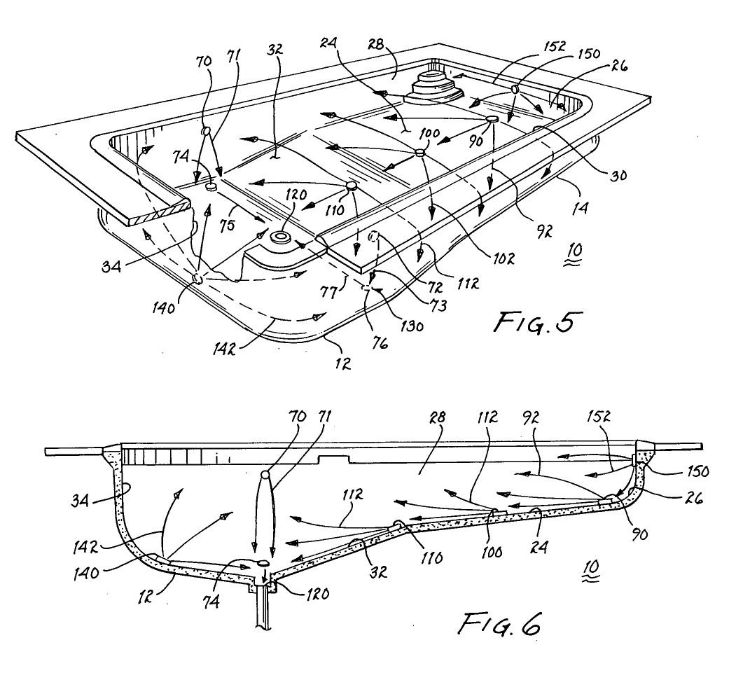

FIGS. 5 and 6 illustrate a variant of the system of nozzles described with respect to FIGS. 3 and 4. Herein, a nozzle 150 (or more than one) is disposed in end wall 26. This nozzle sequentially provides bursts of water, represented by arrows 152, extending through an arc of 180 degrees (180°) with the diametrically opposing flows of water being located close to the surface of the water. The resulting washing action will tend to wash end wall 26 and direct/convey debris therefrom. Any debris dislodged from the end wall and sections of side walls 28, 30 proximate end wall 26 will be conveyed toward deep end 12. Similarly, any debris on bottom surface 24 proximate the end wall will be directed along the bottom surface toward the deep end. Nozzle 90 (as described above) is located downstream of nozzle 150 and provides bursts of water through an arc of about 180 degrees (180°). Any debris urged toward the deep end by the bursts of water from nozzle(s) 150 will become entrained with the bursts of water from nozzle(s) 90 and will be further conveyed toward the deep end. Thereby, nozzle(s) 150 channels water from the shallow end to the flows of water emanating from the next downstream nozzle(s) in the direction of the deep end. Further nozzle(s) 100 perform similarly and pick up debris channeled thereto by the upstream 180 degree (180°) nozzle(s) 90. The remaining nozzle(s) 110 will convey debris channeled by nozzle(s) 100 toward the deep end and into influence of the cleaning system formed by nozzles 70, 72, 74 and 76, as described above. Nozzle(s) 140 are disposed at the lower end of end wall 34 and provide bursts of water, as represented by arrows 142, to convey debris laterally into influence of the cleaning system of nozzles 70, 72, 74 and 76 and toward a collection zone attendant outlet 120. Because of the steepness of end wall 34 little, if any, debris will rest thereon and scrubbing of this area may not be necessary.

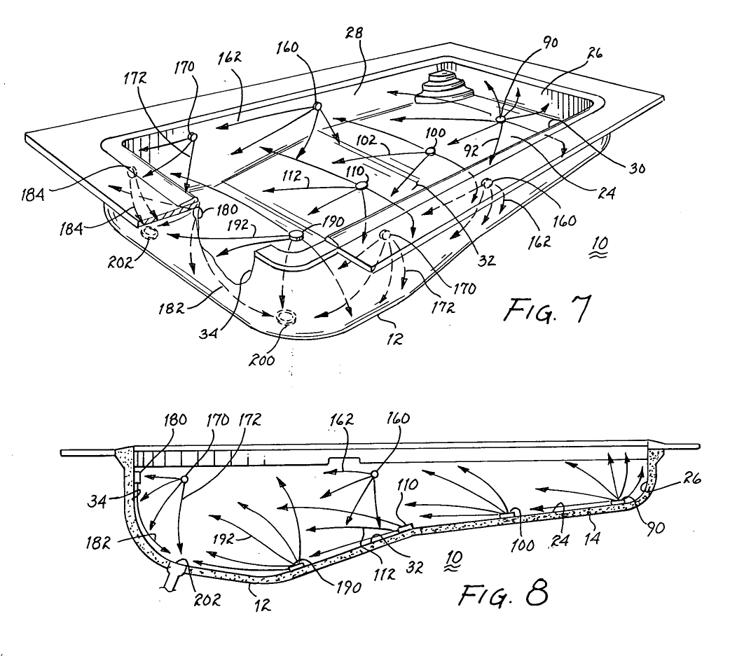

Referring to FIGS. 7 and 8, there is illustrated a yet further variant of the pool shown in FIGS. 3 and 4. Herein, additional side wall nozzles are employed to channel water, debris and suspended debris laterally along the side walls as well as toward the bottom surface. In particular, opposed pair of nozzles 160 provide sequential bursts of water, represented by arrows 162, through an arc of approximately 90 degrees (90°) extending from an orientation essentially parallel to and adjacent the top surface of the pool water to a burst of water extending essentially vertically downwardly toward the bottom surface. Thereby, nozzles 160 channel any debris flowing along the side walls of the pool toward the deep end. A yet further pair of nozzles 170 may be disposed in the respective side walls to provide bursts of water represented by arrows 172 through a 90 degree (90°) arc. These bursts of water continue the flow of debris conveyed by nozzles 160 toward the deep end as well as laterally along the side walls. A nozzle 180 is disposed in end wall 34 at deep end 12 to provide bursts of water, represented by arrows 182, through an arc of approximately 180 degrees (180°) extending from diametrically opposed directions proximate the top surface of the pool water to a vertical flow downwardly. To augment the flow along end wall 34, additional 90 degree (90°) nozzles 184 may be disposed proximate side walls 28, 30. For example, these nozzles would be 90 degree (90°) or 45 degree (45°) nozzles to provide bursts of water downwardly and/or laterally, as represented by arrows 186. A yet further 180 degree (180°) nozzle(s) 190 is provided at the deep end to channel water laterally in opposed directions and toward the end wall at the deep end, as represented by arrows 192. This nozzle(s) assists in channeling any debris conveyed toward the deep end by upstream nozzles, such as nozzles 110, 100. In the embodiment shown in FIGS. 7 and 8, a pair of outlets 200, 202 are disposed proximate the corners of the pool in the deep end. In summary, debris is channeled along the side walls both laterally and downwardly in a cascade manner to continually augment in a cascading manner the flow of the debris to a collection zone attendant outlets 200, 202 until it is ultimately discharged into one of outlets 200, 202.

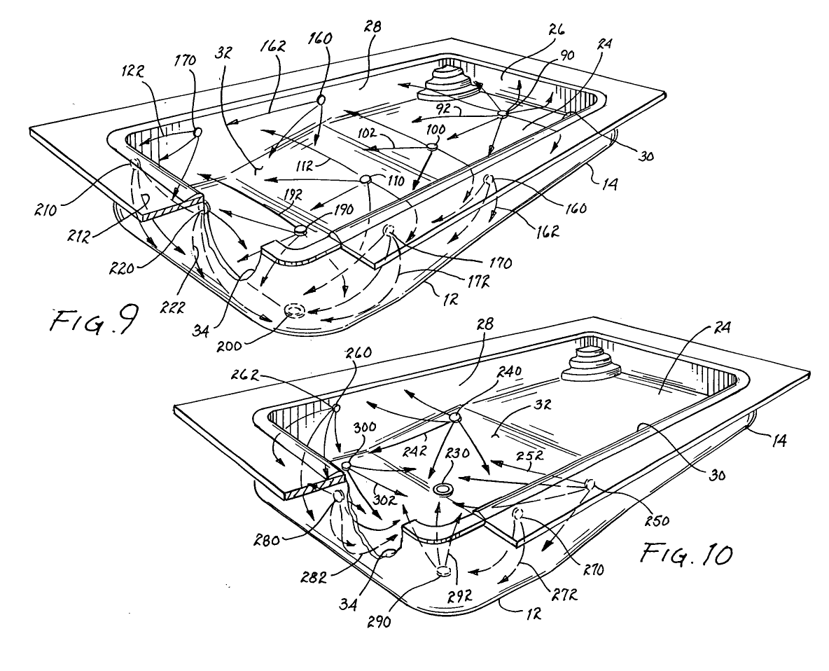

FIG. 9 illustrates a further embodiments similar to that shown in FIGS. 8 and 9 except that deep end 12 includes a single outlet 200 disposed proximate one corner of the deep end. Furthermore, a pair of 90 degree (90°) sequentially actuated nozzles 210, 220 channel water laterally and downwardly along the surface of end wall 34, as represented by arrows 212, 222, respectively, to encourage lateral and downward flow of the debris toward a collection zone proximate outlet 200. The flow from nozzles 210, 220 will tend to augment the flows of debris caused by nozzles 170, 190 toward outlet 200, as well as the upstream flows from nozzles 160, and 110.

Referring to FIG. 10 there is shown a particularly suitable arrangement for forcing debris attendant the end wall and side walls close to the deep end, debris along the bottom surface of the deep end and debris along inclined section 32 into a collection zone and toward a generally centrally located outlet 230. Herein, a pair of 90 degree (90°) nozzles 240, 250 cause sequential bursts of water, represented by arrows 242, 252, respectively, along the bottom in the general direction of outlet 230 and along the respective side walls. 90 degree (90°) nozzles 260, 270 disposed proximate the water surface in side walls 28, 30 urge water flow, represented by arrows 262, 272, respectively, along the side walls toward the end wall and vertically downwardly. The flow of water and suspended debris along the side walls and the end wall are encouraged to flow downwardly, represented by arrows 282, by 180 degree (180°) nozzle 280 located generally centrally of the end wall. Each pair of 90 degree (90°) nozzles 290, 300 disposed at the bottom corners of the deep end provide bursts of water through an arc of 90 degrees (90°) generally toward outlet 230, as represented by arrows 292, 302, respectively. These bursts of water convey and channel water and debris from outflows of adjacent nozzles toward outlet 230.

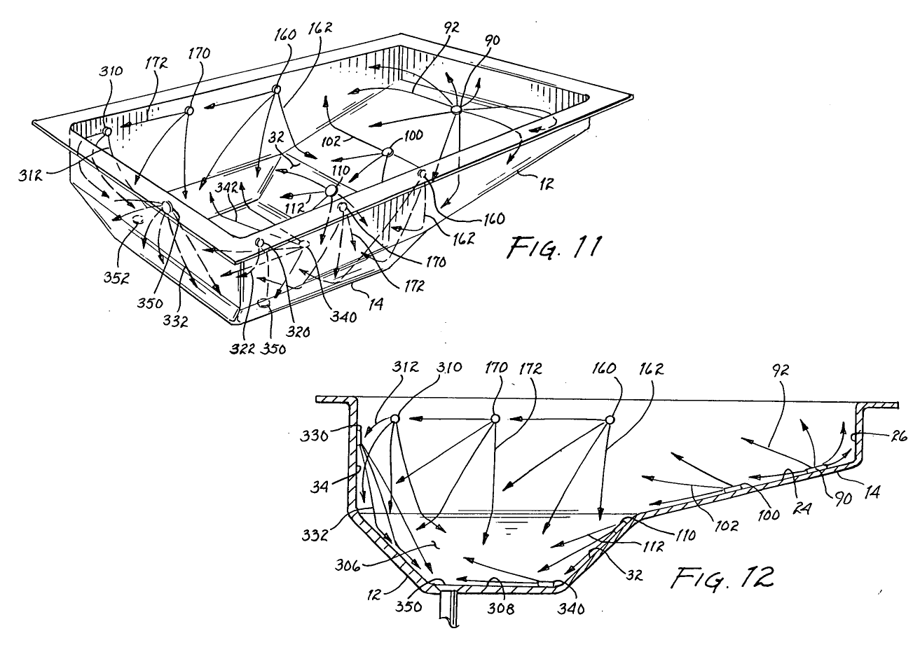

FIGS. 11 and 12 illustrate a perspective and a cross sectional view, respectively, of a vinyl lined pool which is often used in climates wherein freezing in the winter time is a normal occurrence. These pools are generally excavations into the ground, which excavations are lined with a plastic liner, such as vinyl. Because of construction requirements of such a liner, the pool includes a hopper section 306 generally corresponding with deep end 14 of a conventional pool. For greatest efficiency and expunction of debris on the side walls, end walls and bottom surfaces of the liner an arrangement of nozzles similar to that shown in FIG. 9 is employed. Accordingly, common elements will be identified with common numerals. However, additional side wall mounted 90 degree (90°) nozzles 310, 320 may be employed to encourage flow of debris, represented by arrows 312, 322, respectively, past the corner between side walls 28, 30 and end wall 34 at deep end 12. Such flows generally extend through an arc of 90 degrees (90°) from a direction generally parallel and close to the surface of the water to an essentially downward vertical direction. Nozzle 330, which may be either a 90 degree (90°) or a 180 degree (180°) nozzle may be disposed in end wall 34 close to the top to cause debris to flow downwardly and laterally, as represented by arrows 332. A further nozzle 340 may be disposed at bottom 308 of hopper section 306 to prevent collection of debris at the angular junction between downwardly inclined surface 32 of the hopper section and the generally flat portion at the bottom. That is, nozzle(s) 340 would provide bursts of water (arrows 342) to augment and carry forward the flow of water and debris emanating from the nozzles (110) disposed on the inclined surfaces. The outlet may include a single outlet 350 and a second outlet 352, each of which may be disposed in the essentially flat bottom 308 close to the side walls and the inclined surface extending from the vertical end wall at the deep end.

In summary, each of the embodiments illustrated provides a continuing flow of water along the submerged surfaces of the pool ultimately terminating at a respective outlet. Such continuity of flow will have the effect of channeling, conveying, and/or transporting debris therewith and few, if any, dead spots of flow will exist. It is particularly to be noted that the bursts of water from any nozzle does not impede or flow in a direction contradictory to the flow(s) from any other nozzle(s). Thus, a flow initiated by one nozzle is continued by a downstream subsequent nozzle until the flow ultimately is exhausted through an outlet and the debris is conveyed there with.

1. A method for removing debris from a swimming pool having a first end, a second end, side walls, a bottom surface, incrementally rotatable nozzles for providing bursts of water into the pool, a quantity of water and at least one outlet for the water, said method comprising the steps of:
a) discharging water into the swimming pool through a first nozzle disposed proximate the first end for directing water and any conveyed debris along the first end, the side walls extending from the first end and the bottom surface extending from the first end toward the outlet;
b) further discharging water into the swimming pool through a second nozzle disposed between the first nozzle and the outlet for directing water and any conveyed debris along the side walls toward the outlet and along the bottom surface toward the outlet to augment the flow of water and conveyed debris from the first nozzle; and
c) yet further discharging water into the swimming pool through a third nozzle disposed proximate the second end for directing water and any conveyed debris along the second end, the side walls extending from the second end and the bottom surface extending from the second end toward the outlet.

2. The method as set forth in claim 1 including the step of directing water from fourth and fifth nozzles, one of which is disposed in each side wall along the respective side wall toward the outlet.

3. The method as set forth in claim 1 including the step of still further discharging water into the swimming pool through a fourth nozzle disposed between the second nozzle and the outlet for directing water and any conveyed debris along the side walls toward the outlet and along the bottom surface toward the outlet to augment the flow of water and conveyed debris form the second nozzle.

4. The method as set forth in claim 1 wherein said step of further discharging directs a flow of water through an arc of 360 degrees (360°) generally toward the outlet.

5. The method as set forth in claim 1 wherein said step of further discharging directs a flow of water through an arc of 180 degrees (180°) generally toward the outlet.

6. The method as set forth in claim 1 wherein said step of yet further discharging directs a flow of water through an arc of 180 degrees (180°) generally toward the outlet.

7. The method as set forth in claim 2 wherein said step of directing directs a flow of water from each of the fifth and sixth nozzles through an arc of 90 degrees (90°) generally toward the outlet.

8. The method as set forth in claim 4 wherein said steps of further discharging and yet further discharging directs a flow of water through an arc of 180 degrees (180°) generally toward the outlet.

9. The method as set forth in claim 8 including the step of directing water from fourth and fifth nozzles, one of which is disposed in each side wall, along the respective side wall toward the outlet.

10. The method as set forth in claim 9 wherein said step of directing directs a flow of water from each of the fourth and fifth nozzles through an arc of 90 degrees (90°) generally toward the outlet.

11. The method as set forth in claim 1 including the step of directing water from a fourth nozzle disposed in one of the first and second end walls along the respective end wall and toward the side walls and bottom surface.

12. The method as set forth in claim 11 wherein said step of directing directs a flow of water through an arc of 180 degrees (180°) generally toward the outlet.

13. The method as set forth in claim 10 including the step of further directing water from a sixth nozzle disposed in one of the first and second end walls along the respective end wall and toward the side walls and bottom surface.

14. The method as set forth in claim 13 wherein said step of further directing directs a flow of water through an arc of 180 degrees (180°) generally toward the outlet.

15. The method as set forth in claim 14 wherein said step of discharging directs a flow of water from the first nozzle through an arc of 180 degrees (180°) generally toward the outlet.

16. The method as set forth in claim 11 including the step of further directing water from a fifth nozzle disposed in the other of the first and second end walls along the respective end wall and toward the side walls and bottom surface.

17. The method as set forth in claim 16 wherein said step of further directing directs a flow of water through an arc of 180 degrees (180°) generally toward the outlet.

18. A method for removing debris from a swimming pool having a first end, a second end, side walls, a bottom surface, a quantity of water and at least one outlet for the water, said method comprising the steps of:
a) discharging bursts of water through a first incrementally rotating nozzle along the bottom surface through an arc generally toward the outlet;
b) further discharging bursts of water through a second incrementally rotating nozzle along the bottom surface through an arc generally toward the first nozzle;
c) still further discharging bursts of water through a third incrementally rotating nozzle along the bottom surface through an arc generally toward the outlet; and
d) yet further discharging bursts of water through a fourth incrementally rotating nozzle disposed in one of the side walls and through a fifth incrementally rotating nozzle disposed in the other of the side walls along the respective side walls through respective arcs generally toward the outlet.

19. The method as set forth in claim 18 including the step of directing bursts of water through a sixth incrementally rotating nozzle disposed in one of the side walls along the respective side wall through an arc generally toward the outlet.

20. The method as set forth in claim 19 including the step of further directing bursts of water through a seventh incrementally rotating nozzle disposed in the other of the side walls along the respective side wall through an arc generally toward the outlet.

21. The method as set forth in claim 18 wherein said step of discharging and further discharging are carried out by the first and second nozzles being disposed between the outlet and the first end and wherein said step of still further discharging is carried out by the third nozzle being disposed between the outlet and the second end.

22. The method as set forth in claim 21 including the step of directing bursts of water through a sixth incrementally rotating nozzle disposed in one of the side walls along the respective side wall through an arc generally toward the outlet.

23. The method as set forth in claim 22 including the step of further directing bursts of water through a seventh incrementally rotating nozzle disposed in the other of the side walls along the respective side wall through an arc generally toward the outlet.

24. The method as set forth in claim 23 including the step of ejecting bursts of water through an eighth incrementally rotating nozzle disposed in one of the first and second end walls along the respective end wall through an arc generally toward the outlet.

25. The method as set forth in claim 24 including the step of further ejecting bursts of water through a ninth incrementally rotating nozzle disposed in the other of the first and second end walls along the respective end wall through an arc generally toward the outlet.

26. In a swimming pool having first and second ends, opposed side walls, a bottom surface and an outlet, the improvement comprising in combination:
a) a first incrementally rotating nozzle disposed in the bottom surface for discharging bursts of water through an arc of at least 180 degrees (180°) generally toward one side of the outlet;
b) a second incrementally rotating nozzle disposed in the bottom surface for discharging bursts of water through an arc of 180 degrees (180°) generally toward said first nozzle;
c) a third incrementally rotating nozzle disposed in the bottom surface for discharging bursts of water through an arc of 180 degrees (180°) generally toward said an other side of the outlet;
d) a fourth incrementally rotating nozzle disposed in one side wall for discharging bursts of water through an arc of 90 degrees (90°) generally toward the outlet; and
e) a fifth incrementally rotating nozzle disposed in the other side wall for discharging bursts of water through an arc of 90 degrees (90°) generally toward the outlet.

27. A swimming pool as set forth in claim 26 including a sixth incrementally rotating nozzle disposed in one of the first and second ends for discharging bursts of water through an arc of 180 degrees (180°) generally toward the bottom surface and the side walls.

28. A swimming pool as set forth in claim 27 including a seventh incrementally rotating nozzle disposed in the other of the first and second ends for discharging bursts of water through an arc of 180 degrees (180°) generally toward the bottom surface and the side walls.
